(19) United States
(12) Patent Application Publication
(10) Pub. No.: US 2006/0032996 A1
(43) Pub. Date: Feb. 16, 2006

(54) Fastening assembly for detachably mounting an onboard LCD between a headrest and a backrest

(76) Inventor: Tai-Hsiung Wu, Taoyuan (TW)

Correspondence Address: DELLETT & WALTERS, P. O. BOX 82788, PORTLAND, OR, 97282-0788, US

(21) Appl. No.: 10/915,971

(22) Filed: Aug. 11, 2004

(51) Int. Cl. A47B 96/06; E04G 5/06; F21V 35/00

(52) U.S. Cl. 248/218.4

(57) ABSTRACT

A fastening assembly includes two fixing bars detachably connected to each other via fixing bolts for sandwiching therebetween the two fixing rods, a supporting bracket movably connected to the two fixing bars and having a supporting plate extending inclinedly relative to the two fixing bars, an adjusting device having a pivot pivotably received therein and rotatably connected to the supporting plate and an attachment-portion having a front face adapted for secure engagement with the liquid crystal display and a rear face detachably connected to the adjusting device such that the liquid crystal display angle is able to be changed via the rotation of the adjusting device together with the pivot and via the pivotal movement of the adjusting device relative to the pivot.

### BACKGROUND OF THE INVENTION

1. Field of the Invention

The present invention relates to a fastening assembly, and more particularly to a fastening assembly for detachably mounting an onboard liquid crystal display between a headrest and a backrest.

2. Description of Related Art

Currently, in order to entertain the passengers, onboard movies seem to be a very successful way to allow the passenger to forget the boredom and fatigue that arise during a long journey, especially in a car. Nowadays, the onboard movie player mainly depends on a liquid crystal display (LCD) because of its high picture resolution and compactness. To mount the LCD in a car, the rear side of the backrest or the headrest normally is defined with a recess so that the LCD is able to be received in the recess. However, mounting the LCD in the car in this way limits the passengers' watching pleasure because the angle of the LCD can only be adjusted within a limited range. Still, due to the mounting of the LCD in the car being fixed, the car owner is not able to safeguard the LCD from being stolen especially when the car is outside in the street.

To overcome the shortcomings, the present invention tends to provide an improved fastening assembly to mitigate the aforementioned problems.

### SUMMARY OF THE INVENTION

The primary objective of the present invention is to provide an improved fastening assembly for detachably mounting the LCD so that the user is able to detach the LCD as required.

Another objective of the present invention is to provide a fastening assembly to allow an angle change of the LCD to provide the maximum watching pleasure.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of the fastening assembly of the present invention;

FIG. 2 is a perspective view showing the assembly of the fastening assembly of the present invention;

FIG. 3 is a schematic side plan view showing the angle change of the fastening assembly;

FIG. 4 is a top plan view showing position of the fastening assembly with respect to the positioning bars between the headrest and the backrest;

FIGS. 5A and 5B are schematic views showing the separation between the attachment portion and the fixing portion;

FIG. 6 is a schematic side plan view showing that the attachment portion is securely attached to a rear side of the LCD and the attachment portion is adapted for allowing the LCD to pivot relative to the fixing portion; and

FIG. 7 is a schematic view showing that the attachment portion is rotatable relative to the fixing portion such that the LCD is able to be rotated.

### DETAILED DESCRIPTION OF THE PREFERRED EMBODIMENT

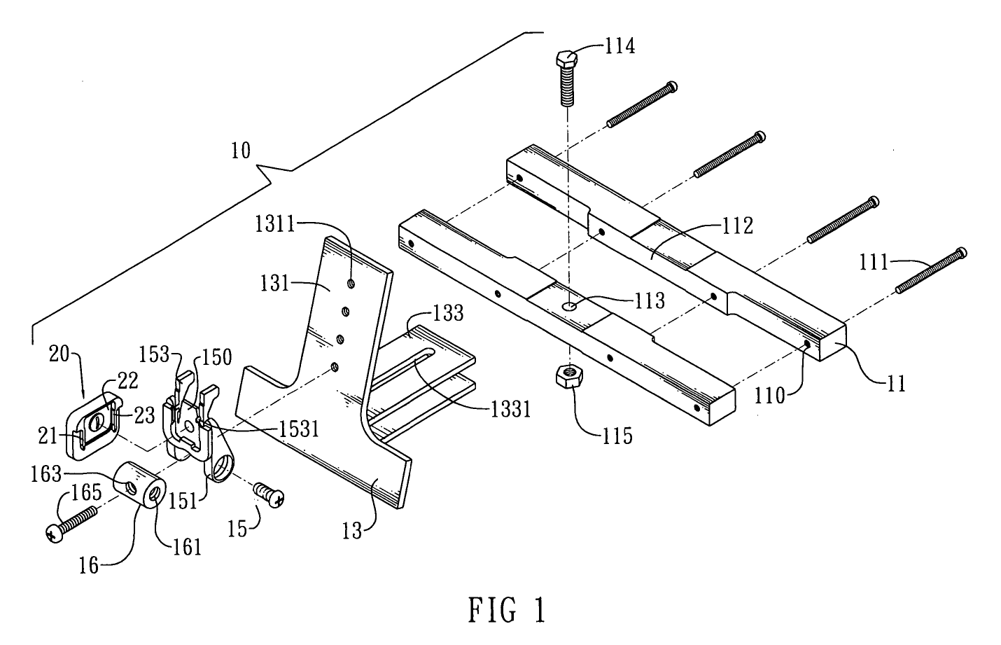

With reference to FIG. 1, the fastening assembly in accordance with the present invention includes a fixing portion (10) and an attachment portion (20).

The fixing portion (10) has two fixing bars (11), a supporting bracket (13), an adjusting device (15) and a pivot (16). Each fixing bar (11) is an elongated element with multiple fixing holes (110) defined through the fixing bar (11) to correspond to and align with the fixing holes (110) of the other fixing bar (11) and a protruding portion (112) formed on a central portion of the fixing bar (11) to face the protruding portion (112) of the other fixing bar (11). Thus when multiple fixing bolts (111) are threadingly extended through the aligned fixing holes (110) of the two fixing bars (11), the two fixing bars (11) are combined with the two protruding portions (112) facing each other and securely engaged with one another. As a consequence of the secure engagement between the two protruding portions (112) of the two fixing bars (11), two spaces (not numbered) are thus defined in opposite portions of the combination of the two fixing bars (11). One of the fixing bars (11) is provided with a through hole (113) to allow an extension of a first adjusting bolt (114) to combine with a first nut (115).

The supporting bracket (13) has a supporting plate (131) and at least one (two are shown in the drawing) securing plate (133) fixedly extending from and being inclined relative to a rear side of the supporting plate (131). The supporting plate (131) has multiple threaded holes (1311) defined through the supporting plate (131). The securing plate (133) has a slit (1331) defined through the securing plate (133) to communicate with the through hole (113) of the fixing bar (11). In this embodiment, there are two securing plates (133) spaced apart from each other in order to have the communication between the slits (1331) and the through hole (113), and the two securing plates (133) are sandwiched therebetween the two fixing bars (11).

The adjusting device (15) has a central hub (150), two ears (151) respectively extending downward from two opposed sides of the central hub (150) and two fingers (153) respectively extending upward from the two opposed sides of the central hub (150) and each having an extension (1531) extending out from the finger (153). It is noted that the opposed sides of the central hub (150) are truncated such that a gap is defined between the central hub (150) and the finger (153) to allow the two fingers (153) to move toward each other.

The pivot (16) is securely sandwiched between the two ears (151) and has a laterally defined passage (161) to allow two bolts (not numbered) to respectively extend through the two ears (151) and into the passage (161) from opposite directions to secure the pivot (16) between the two ears (151) and a threaded path (163) perpendicular to and communication with the passage (161) is defined to correspond to a securing bolt (165) so that the securing bolt (165) is able to extend through the threaded path (163) and into a corresponding one of the threaded holes (1311) in the supporting plate (131).

The attachment portion (20) is detachably connected to the fixing portion (10) and has two sliding tracks (21) respectively defined in opposed sides of the attachment portion (20) to correspond to the two extensions (1531), a raised face (22) centrally formed on the attachment portion (20) such that the raised face (22) is sandwiched by the two sliding tracks (21) and two shoulders (23) respectively formed on distal ends of each of the sliding tracks (21) to receive therein the two extensions (1531) after the two extensions (1531) are slid into the sliding tracks (21).

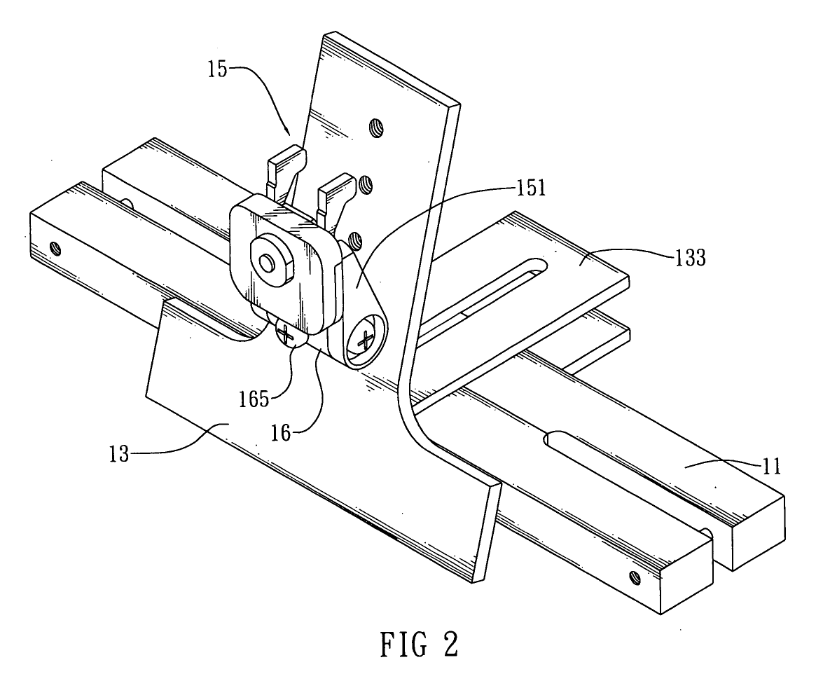

With reference to FIG. 2 and still using FIG. 1 for reference, after the fastening assembly of the present invention is assembled, it is noted that the two fixing bars (11) are clamped by the two securing plates (133) and the supporting plate (131) is abutted against one of the fixing bars (11). The securing bolt (165) is threadingly extended through the threaded path (163) of the pivot (16) and into a corresponding one of the threaded holes (1311) in the supporting plate (131) so that the pivot (16) is securely connected to the supporting plate (131). Furthermore, the two bolts are threadingly extended through the two ears (151) and into the passage (161) from opposite directions to secure the position of the pivot (16) relative to the adjusting device (15).

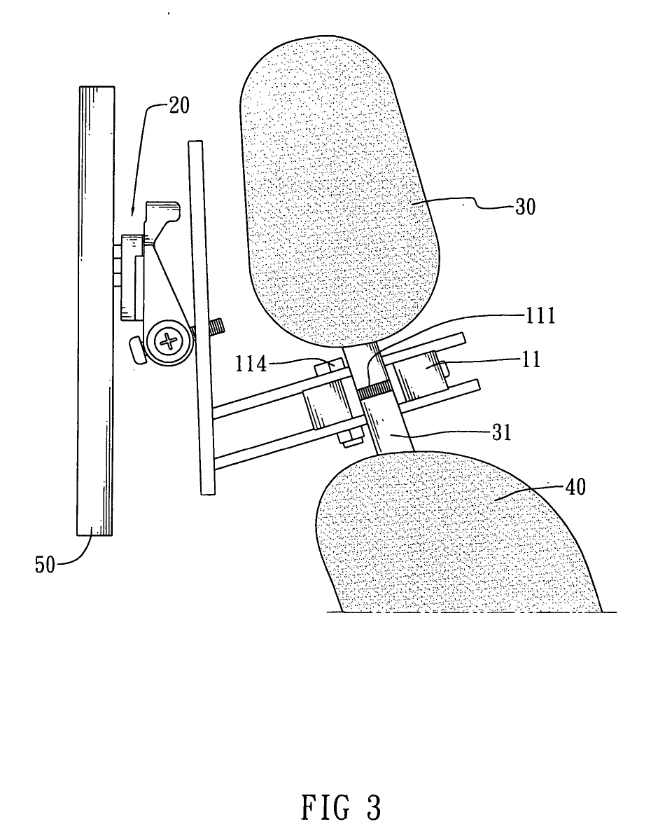

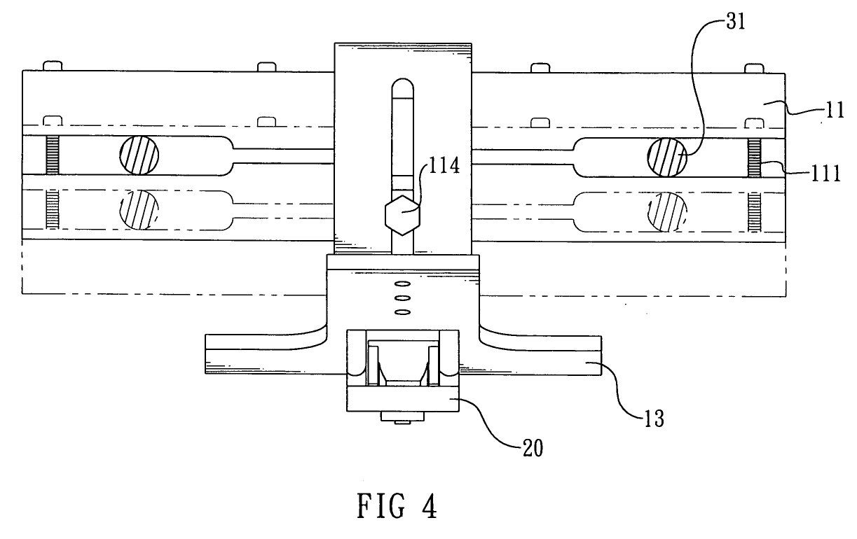

With reference to FIGS. 3 and 4, it is noted that after a liquid crystal display (LCD) (50) is securely attached to a side face of the attachment portion (20) of the present invention, fixing rods (31) extending from a headrest (30) are extended between the two fixing bars (11) and received in the two spaces respectively. Therefore, with the fastening strength of the fixing bolts (111) extending between the two fixing bars (11), the fixing rods (31) are securely clamped by the fixing bars (11).

Furthermore, a user is able to loosen engagement of the adjusting bolt (114) which is extended through the slits (1331) of the securing plates (133) and the through hole (113) of one of the fixing bars (11) to combine the first nut (115) so that the supporting bracket (13) is slidable relative to the fixing bars (11). After the position of the supporting bracket (13) is determined, the user then tightens the adjusting bolt (114) to secure the engagement between the securing plates (133) and the fixing bar (11).

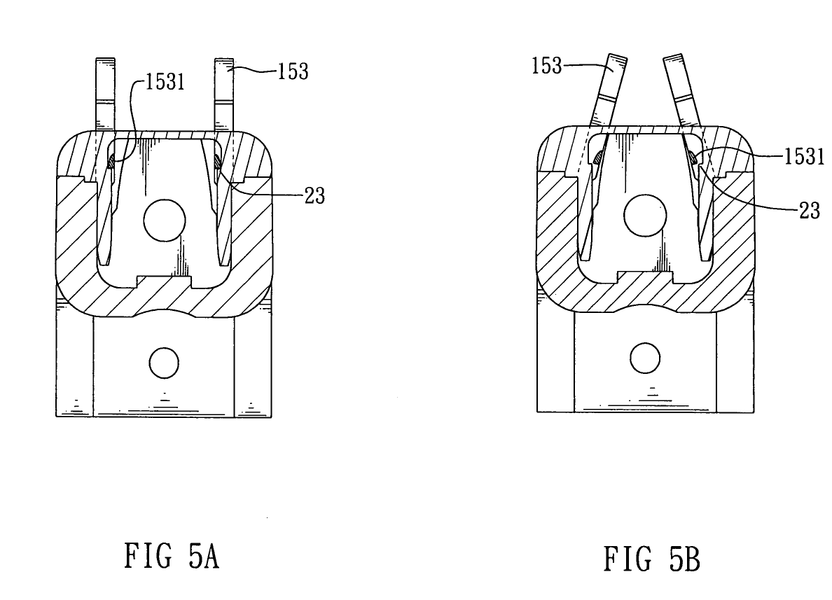

With reference to FIGS. 5A and 5B, it is noted that the when the adjusting device (15) is to be assembled with the attachment portion (20), the two extensions (1531) are slid into the two sliding tracks (21) until the two extensions (1531) reach the distal ends of the two sliding tracks (21), where the two extensions (1531) are rested in the shoulders (23). When detachment between the attachment portion (20) and the adjusting device (15) is required, the user is able to move the two fingers (153) toward each other such that the two extensions (1531) are away from the respective shoulders (23) and thus the attachment device (20) is freely detachable relative to the adjusting device (15).

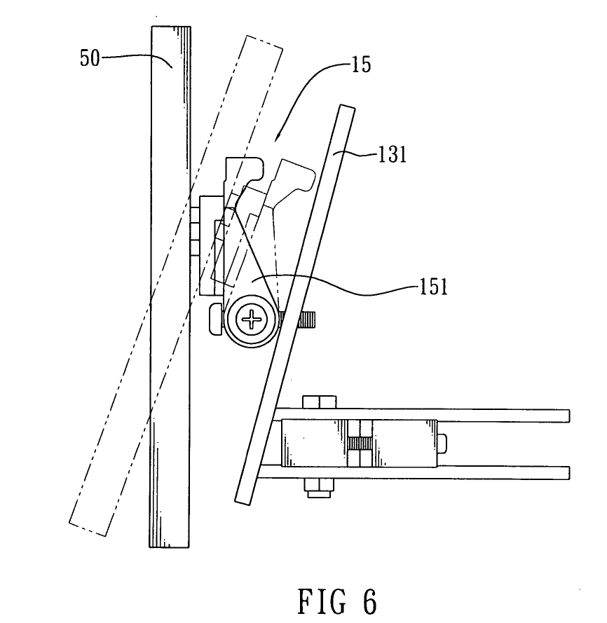

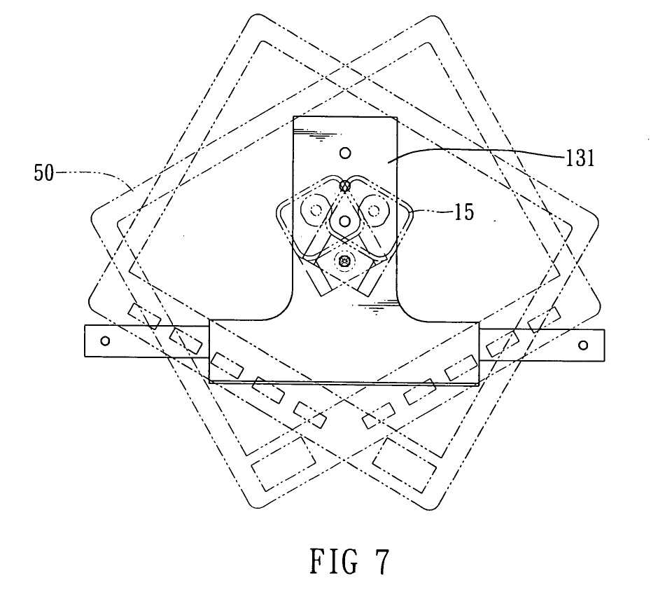

With reference to FIGS. 6 and 7, it is noted that because the pivot (16) is sandwiched between the two ears (151) by the bolt, the adjusting device (20) is thus pivotable relative to the supporting bracket (13), as shown in FIG. 6. Thus the LCD (50) is able to be tilted in different directions. Also, because the engagement between the adjusting device (15) and the supporting bracket (13) is based on threading the extension of the securing bolt (165) into the corresponding one of the threaded holes (1311) of the supporting plate (131), the attachment portion (20) is rotatable relative to the supporting plate (131), as shown in FIG. 7. Due to the rotatable feature of the attachment portion (20) relative to the supporting plate (131), the LCD (50) angle is changeable.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A fastening assembly for detachably mounting an onboard liquid crystal display between a headrest having two fixing rods extending downward from a side face of the headrest and a backrest, the fastening assembly comprising:
two fixing bars detachably connected to each other via fixing bolts for sandwiching therebetween the two fixing rods;
a supporting bracket adaptable for movably connection to the two fixing bars and having a supporting plate integrally formed and extending inclinedly relative to the two fixing bars;
an adjusting device having a pivot pivotably received therein and rotatably connected to the supporting plate so that the adjusting device is able to be pivoted relative to the pivot and the adjusting device together with the pivot is able to rotate relative to the supporting plate; and
an attachment portion having a front face adapted for secure engagement with the liquid crystal display and a rear face detachably connected to the adjusting device such that the liquid crystal display angle is able to be changed via the rotation of the adjusting device together with the pivot and via the pivotal movement of the adjusting device relative to the pivot.

2. The fastening assembly as claimed in claim 1, wherein the supporting bracket further has two securing plates each having a slit defined through the securing plate to correspond to and communicate with a through hole defined in one of the two fixing bars such that an adjusting bolt is able to extend through the slits and the through hole to combine with a nut, whereby a position of the supporting bracket is able to be changed via movement of the adjusting bolt in the slits.

3. The fastening assembly as claimed in claim 1, wherein the adjusting device has two ears extending downward from opposed sides of a truncated central hub and the pivot is pivotally received between the two ears and rotatably connected to the supporting plate so that the adjusting device is pivotable in relation to the pivot, and the adjusting device together with the pivot is rotatable with respect to the supporting plate.

4. The fastening assembly as claimed in claim 2, wherein the adjusting device has two ears extending downward from opposed sides of a truncated central hub and the pivot is pivotally received between the two ears and rotatably connected to the supporting plate so that the adjusting device is pivotable in relation to the pivot, and the adjusting device together with the pivot is rotatable with respect to the supporting plate.

5. The fastening assembly as claimed in claim 4, wherein the adjusting device further has two fingers extending upward from the opposed sides of the truncated central hub and each having an extension extending outward therefrom,
the attachment portion has two sliding tracks formed on opposed sides of the rear face to correspond to and slidably receive therein the two extensions of the two fingers such that the attachment portion is detachably connected to the adjusting device.

6. The fastening assembly as claimed in claim 5, wherein the attachment portion further has two shoulders respectively formed on distal ends of the two sliding tracks to stop the two extensions after the two extensions are slid into the two sliding tracks.

7. The fastening assembly as claimed in claim 1, wherein the pivot has a passage laterally defined through the pivot and a threaded path in communication with the passage to correspond to one of multiple threaded holes defined in the supporting plate so that a securing bolt is able to extend through the threaded path and into a corresponding one of the threaded holes to secure engagement between the pivot and the supporting plate,
whereby due to the rotatable connection between the pivot and the supporting plate and the pivotal relationship between the pivot and the adjusting device, after the front face is secured with the liquid crystal display, an angle of the liquid crystal display is changeable.

8. The fastening assembly as claimed in claim 2, wherein the pivot has a passage laterally defined through the pivot and a threaded path in communication with the passage to correspond to one of multiple threaded holes defined in the supporting plate so that a securing bolt is able to extend through the threaded path and into a corresponding one of the threaded holes to secure engagement between the pivot and the supporting plate,
whereby due to the rotatable connection between the pivot and the supporting plate and the pivotal relationship between the pivot and the adjusting device, after the front face is secured with the liquid crystal display, an angle of the liquid crystal display is changeable.

9. The fastening assembly as claimed in claim 4, wherein the pivot has a passage laterally defined through the pivot and a threaded path in communication with the passage to correspond to one of multiple threaded holes defined in the supporting plate so that a securing bolt is able to extend through the threaded path and into a corresponding one of the threaded holes to secure engagement between the pivot and the supporting plate,
whereby due to the rotatable connection between the pivot and the supporting plate and the pivotal relationship between the pivot and the adjusting device, after the front face is secured with the liquid crystal display, an angle of the liquid crystal display is changeable.

10. The fastening assembly as claimed in claim 5, wherein the pivot has a passage laterally defined through the pivot and a threaded path in communication with the passage to correspond to one of multiple threaded holes defined in the supporting plate so that a securing bolt is able to extend through the threaded path and into a corresponding one of the threaded holes to secure engagement between the pivot and the supporting plate,
whereby due to the rotatable connection between the pivot and the supporting plate and the pivotal relationship between the pivot and the adjusting device, after the front face is secured with the liquid crystal display, an angle of the liquid crystal display is changeable.

11. The fastening assembly as claimed in claim 6, wherein the pivot has a passage laterally defined through the pivot and a threaded path in communication with the passage to correspond to one of multiple threaded holes defined in the supporting plate so that a securing bolt is able to extend through the threaded path and into a corresponding one of the threaded holes to secure engagement between the pivot and the supporting plate,
whereby due to the rotatable connection between the pivot and the supporting plate and the pivotal relationship between the pivot and the adjusting device, after the front face is secured with the liquid crystal display, an angle of the liquid crystal display is changeable.

12. The fastening assembly as claimed in claim 5, wherein the two fingers are able to move from a first position where the two extensions are stopped by the two shoulders of the attachment portion to a second position where the two extensions are away from engagement with the two shoulders to release restriction of the shoulders to the extensions so as to allow the attachment portion to detach from engagement with the adjusting device due to movement of the two fingers toward the truncated central hub.

13. The fastening assembly as claimed in claim 6, wherein the two fingers are able to move from a first position where the two extensions are stopped by the two shoulders of the attachment portion to a second position where the two extensions are away from engagement with the two shoulders to release restriction of the shoulders to the extensions so as to allow the attachment portion to detach from engagement with the adjusting device movement of the two fingers toward due to the truncated central hub.

14. The fastening assembly as claimed in claim 10, wherein the two fingers are able to move from a first position where the two extensions are stopped by the two shoulders of the attachment portion to a second position where the two extensions are away from engagement with the two shoulders to release restriction of the shoulders to the extensions so as to allow the attachment portion to detach from engagement with the adjusting device movement of the two fingers toward due to the truncated central hub.

15. The fastening assembly as claimed in claim 11, wherein the two fingers are able to move from a first position where the two extensions are stopped by the two shoulders of the attachment portion to a second position where the two extensions are away from engagement with the two shoulders to release restriction of the shoulders to the extensions so as to allow the attachment portion to detach from engagement with the adjusting device movement of the two fingers toward due to the truncated central hub.
